(19) United States
(12) Patent Application Publication
(10) Pub. No.: US 2013/0174553 A1
(43) Pub. Date: Jul. 11, 2013

(54) DIFFUSER HAVING FLUIDIC ACTUATION

(71) Applicant: Deepesh Dinesh Nanda, Bangalore (IN)

(72) Inventor: Deepesh Dinesh Nanda, Bangalore (IN)

(73) Assignee: GENERAL ELECTRIC COMPANY, Schenectady, NY (US)

(21) Appl. No.: 13/348,027

(22) Filed: Jan. 11, 2012

(51) Int. Cl. F01D 25/00; F02C 7/00

(52) U.S. Cl. 60/694

(57) ABSTRACT

A diffuser having fluidic actuation therein includes a diffuser inlet and an inner barrel extending from proximate the diffuser inlet in a direction relatively downstream of the diffuser inlet. The diffuser also includes an actuating opening in the inner barrel proximate the diffuser inlet. The diffuser further includes a suction opening in the inner barrel located downstream of the actuating opening. The diffuser yet further includes a flow manipulator disposed substantially within the inner barrel.

### BACKGROUND OF THE INVENTION

The subject matter disclosed herein relates to turbines and, in particular, to diffusers for use with gas turbines and steam turbines.

Typical gas turbines include a diffuser cone, or diffuser, coupled to a last stage bucket of a rotor. The diffuser serves, generally, to increase static pressure of exhaust gas by decreasing the kinetic energy of the exhaust gas. Generally, this may be achieved by increasing the cross-sectional area of the diffuser in the direction of exhaust gas flow.

Often, gas turbines are not operated at full load, but are designed for efficiency under such a full load. Therefore, part load performance efficiency is sacrificed, based on the full load design. Such inefficiencies are due, at least in part, to flow separation on a diffuser inner barrel, leading to tip strong flow profiles.

### BRIEF DESCRIPTION OF THE INVENTION

According to one aspect of the invention, a diffuser having fluidic actuation therein includes a diffuser inlet and an inner barrel extending from proximate the diffuser inlet in a direction relatively downstream of the diffuser inlet. The diffuser also includes an actuating opening in the inner barrel proximate the diffuser inlet. The diffuser further includes a suction opening in the inner barrel located downstream of the actuating opening. The diffuser yet further includes a flow manipulator disposed substantially within the inner barrel.

According to another aspect of the invention, a diffuser for a gas turbine includes a diffuser inlet, a diffuser outlet, and an outer wall extending from proximate the diffuser inlet to proximate the diffuser outlet. The diffuser also includes an inner barrel having at least one actuating opening and at least one suction opening. The diffuser further includes a flow manipulator disposed substantially within the inner barrel.

According to yet another aspect of the invention, a gas turbine includes a turbine casing that surrounds a portion of the gas turbine. The gas turbine also includes a diffuser coupled to the turbine casing. The diffuser includes a diffuser inlet, an inner barrel having an actuating opening and a suction opening, and a flow manipulator disposed substantially within the inner barrel.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a side, cross-sectional view of a diffuser according to one aspect of the invention;

FIG. 2 is a partial side, cross sectional view of the diffuser of FIG. 1;

FIG. 3 illustrates a diffuser flow profile associated with the diffuser illustrated in FIG. 1; and

FIG. 4 illustrates a diffuser flow profile exhibiting tip strong flow.

The detailed description explains embodiments of the invention, together with advantages and features, by way of example with reference to the drawings.

### DETAILED DESCRIPTION OF THE INVENTION

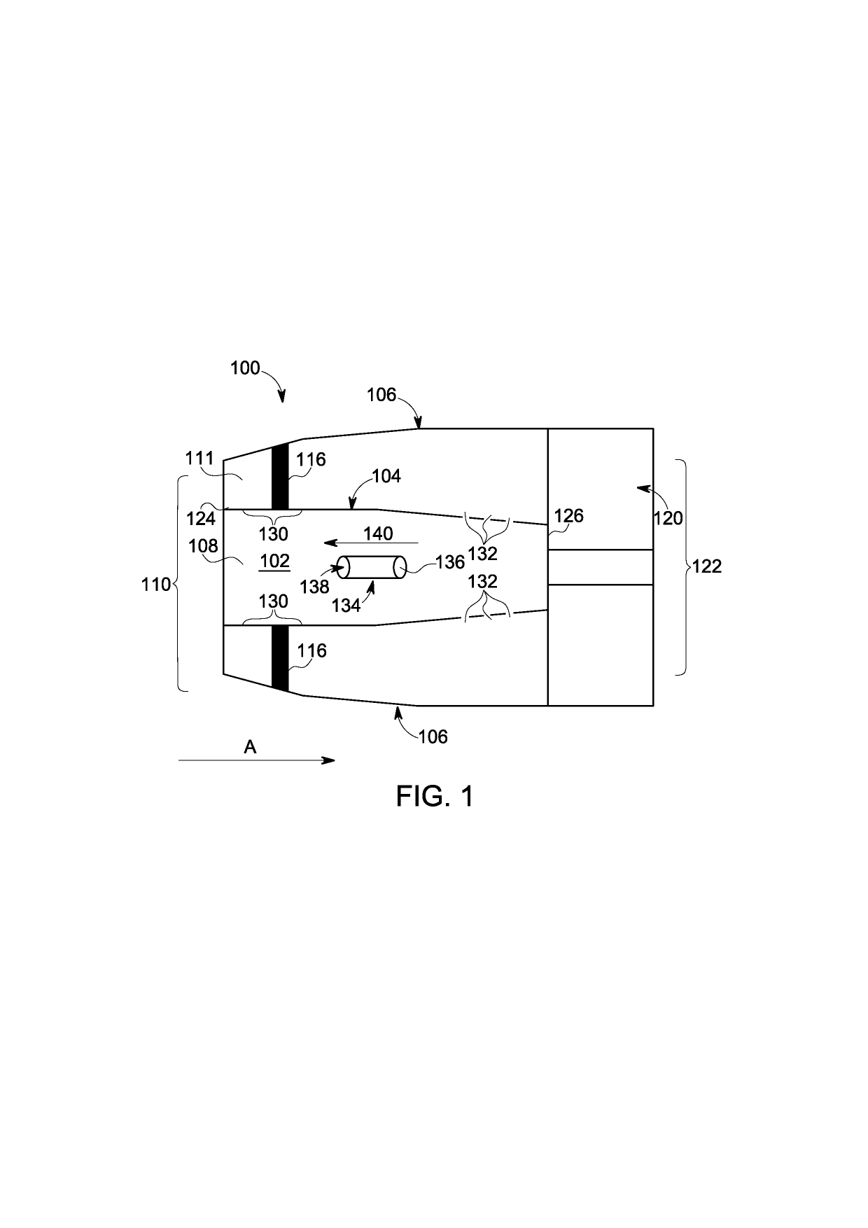

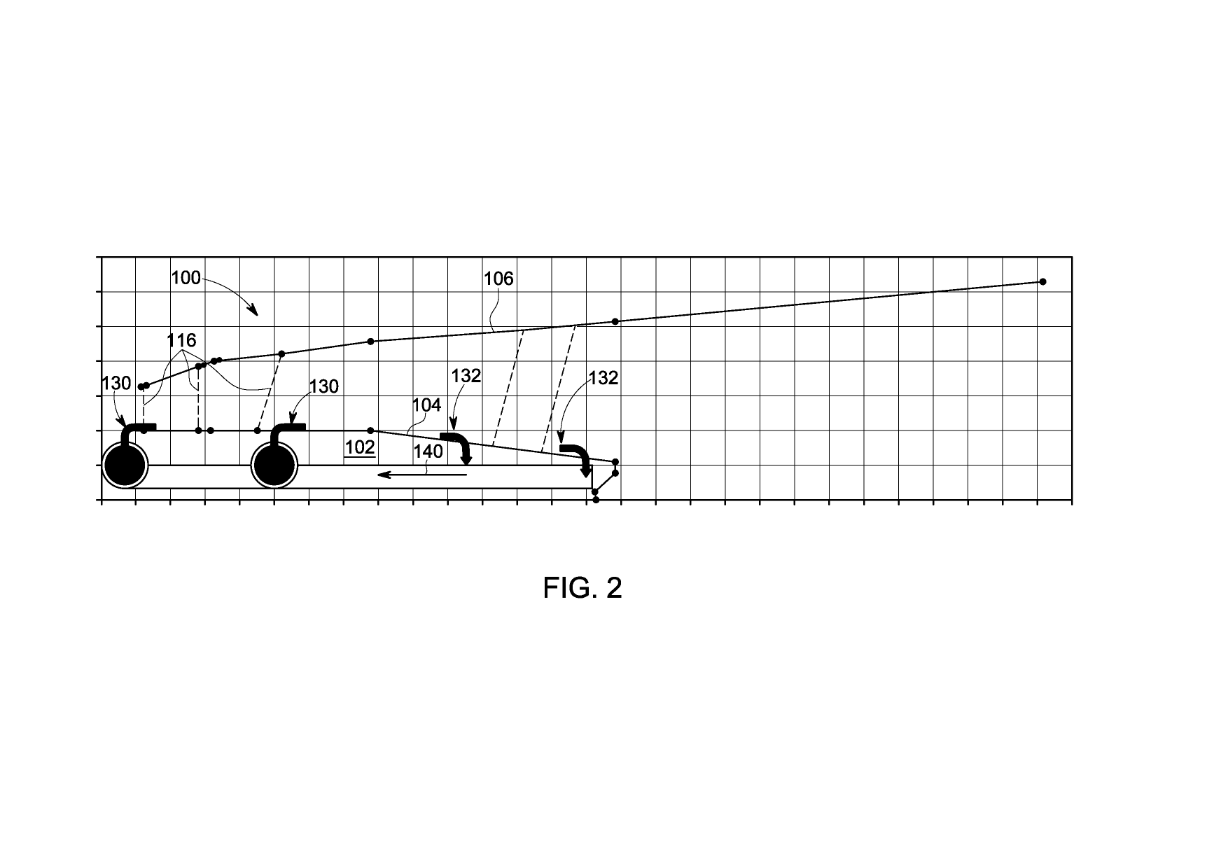

FIGS. 1 and 2 illustrate one aspect of a diffuser 100 according to one embodiment of the present invention. In operation, exhaust gas from the gas turbine flows through the diffuser 100 in the direction shown by arrow A. In this description, an object is “downstream” of another object or location if it is displaced from it in the direction of arrow A and is “upstream” if it is displaced from it in a direction opposite of arrow A.

The diffuser 100 includes an inner barrel 102 having an inner wall 104 that forms an inner chamber 108. The diffuser 100 also has an inlet 111 located proximate a diffuser entry end 110 and an outlet 120 located proximate a diffuser exit end 122. The inlet 111 is capable of being coupled to a turbine, while the outlet 120 is capable of being coupled to an adjacent object, such as a silencer. The diffuser 100 also includes an outer wall 106 radially spaced from the inner wall 104 of the inner barrel 102. The area between the inner wall 104 and the outer wall 106 allows fluid or gas to flow downstream therethrough from the inlet 111 to the outlet 120 of the diffuser 100.

The diffuser 100 also includes one or more struts 116 formed between the inner wall 104 and the outer wall 106. The strut 116 serves to hold the inner wall 104 and the outer wall 106 in a fixed relationship to one another. The number of struts 116 is variable and commonly ranges from about four to about ten.

The inner wall 104 of the inner barrel 102 extends from the diffuser inlet 111, or diffuser entry end 110, in a downstream direction toward the diffuser outlet 120, or diffuser exit end 122. The inner barrel 102, and hence the inner wall 104, includes a first end 124 located proximate the diffuser inlet 111 and a second end 126 located downstream toward the diffuser outlet 120 and takes on numerous longitudinal contours as the inner barrel 102 extends from the first end 124 to the second end 126. The inner barrel 102 may slightly curve continuously from the first end 124 to the second end 126, may curve slightly for only portions between the first end 124 and the second end 126, may extend in a substantially straight direction, or may comprise segmented portions, where the overall longitudinal direction of the inner barrel 102 comprises any combination of the curvilinear paths described above. Irrespective of the shape of the inner barrel 102, and more particularly the inner wall 104, the inner barrel 102 and inner wall 104 extend toward the diffuser outlet 120, or diffuser exit 122, and it is conceivable that the inner barrel 102 and inner wall 104 extend completely to the diffuser outlet 120.

The inner wall 104 of the inner barrel 102 includes one or more actuator openings 130. The inner wall 104 of the inner barrel 102 also includes one or more suction openings 132 that are located downstream of the one or more actuator openings 130. Both the actuator opening 130 and the suction opening 132 may vary in size and shape and may be modified for the application.

Disposed within the inner barrel 102 is a flow manipulating device 134 that may take the form of a pump capable of displacing fluid or gas flow that is captured through the suction opening 132. Typically, weak flow through the diffuser 100 occurs proximate the inner barrel 102, leading to what is characterized as “tip strong” flow, thereby creating system inefficiency. The suction opening 132 allows the common weak flow that passes directly over the inner wall 104 to enter the inner barrel 102 and enter an intake port 136 of the flow manipulating device 134 and is subsequently expelled out of a discharge port 138 of the flow manipulating device 134 with sufficient force to exit the actuating opening 130 in a manner that manipulates the flow profile of the diffuser 100. The manipulation of flow reduces flow separation, thereby increasing diffusion area. The direction of airflow within the inner barrel 102 from a downstream location to an upstream location is illustrated by arrow 140. Although it is envisioned that one flow manipulating device 134 will be sufficient to displace the flow, it is conceivable that a plurality of flow manipulating devices 134 may be employed within the inner barrel 102 to work in conjunction to provide the aforementioned desired function.

As previously described, there may be a plurality of actuator openings 130 and/or suction openings 132, but regardless of the number of each type of opening 130, 132, the suction opening 132 is located downstream of the actuator opening 130. The actuator opening 130 is typically located relatively adjacent the diffuser inlet 111 in order to reduce flow separation early on (i.e., substantially upstream) in the diffuser flow process. It is conceivable that the actuator opening 130 is located at an upstream location relative to one of the struts 116, while the suction opening 132 is located downstream relative to one of the struts 116. Additionally, in the case of multiple actuator openings 130 and suction openings 132, the spacing of each respective group may vary, but in any event, the group of actuator openings 130 will typically be located upstream of the discharge port 138, while the group of suction openings 132 will typically be located downstream of the intake port 136.

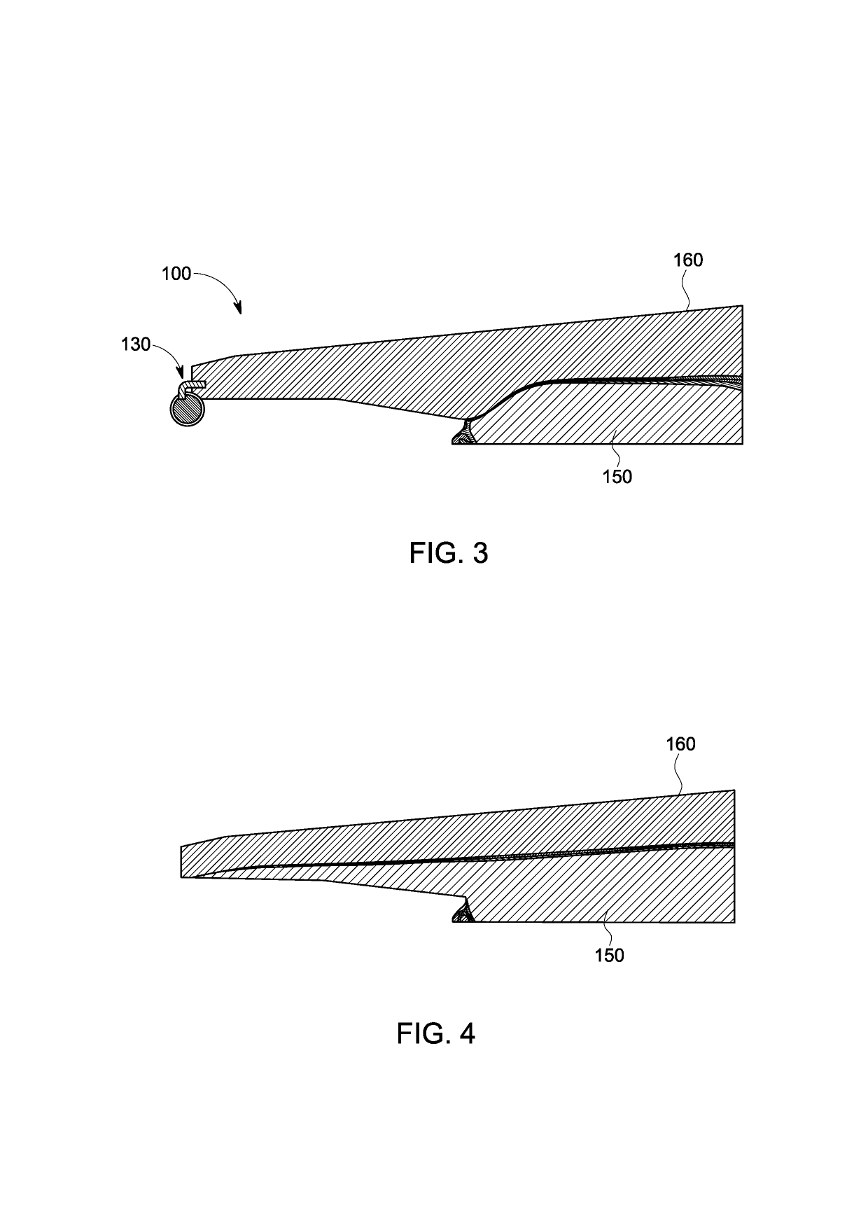

FIG. 3 shows a flow path profile in diffuser 100 shown in FIG. 1. As can be seen, the flow profile for the diffuser 100 of FIG. 1 is strong throughout a large portion of the radial area of the diffuser 100, even along the inner wall 104. The diffuser 100 reduces flow separation, thereby improving diffuser performance over a diffuser flow profile exhibiting flow separation, as shown in FIG. 4. FIGS. 3 and 4 represent what is characterized as “weak flow” by 150, while what is characterized by healthy, efficient “strong flow” is represented by 160.

Advantageously, diffuser 100 reduces flow separation within the diffuser 100, particularly during part load performance of the overall system, by energizing the weak flow boundary layer that is typically present along the inner barrel 102. By providing the flow manipulating device 134, such as a pump, weak flow may be taken from a downstream aft location and injected at an upstream location to improvingly modify the flow profile of the diffuser 100. The result is significant improvement in diffuser performance.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A diffuser having fluidic actuation therein, the diffuser comprising:
a diffuser inlet;
an inner barrel extending from proximate the diffuser inlet in a direction relatively downstream of the diffuser inlet;
an actuating opening in the inner barrel proximate the diffuser inlet;
a suction opening in the inner barrel located downstream of the actuating opening; and
a flow manipulator disposed substantially within the inner barrel.

2. The diffuser of claim 1, wherein the diffuser includes a plurality of actuating openings.

3. The diffuser of claim 1, wherein the diffuser includes a plurality of suction openings.

4. The diffuser of claim 1, wherein the flow manipulator is located substantially between the actuating opening and the suction opening.

5. The diffuser of claim 4, wherein the flow manipulator is a pump that is configured to have an intake port proximate the suction opening and a discharge port proximate the actuating opening.

6. The diffuser of claim 1, further comprising a strut relatively disposed between the inner barrel and an outer wall.

7. The diffuser of claim 6, wherein the actuating opening is located upstream from the strut.

8. A diffuser for a gas turbine comprising:
a diffuser inlet;
a diffuser outlet;
an outer wall extending from substantially the diffuser inlet to substantially the diffuser outlet;
an inner barrel having at least one actuating opening and at least one suction opening; and
a flow manipulator disposed substantially within the inner barrel.

9. The diffuser of claim 8, wherein the diffuser includes a plurality of actuating openings.

10. The diffuser of claim 8, wherein the diffuser includes a plurality of suction openings.

11. The diffuser of claim 8, wherein the flow manipulator is located substantially between the at least one actuating opening and the at least one suction opening.

12. The diffuser of claim 11, wherein the flow manipulator is a pump that is configured to have an intake port proximate the at least one suction opening and a discharge port proximate the at least one actuating opening.

13. The diffuser of claim 8, further comprising a strut relatively disposed between the inner barrel and the outer wall.

14. The diffuser of claim 13, wherein the at least one actuating opening is located upstream from the strut.

15. A gas turbine comprising:
a turbine casing that surrounds a portion of the gas turbine; and
a diffuser coupled to the turbine casing, the diffuser including:
a diffuser inlet;
an inner barrel having an actuating opening and a suction opening; and
a flow manipulator disposed substantially within the inner barrel.

16. The gas turbine of claim 15, wherein the diffuser includes a plurality of actuating openings.

17. The gas turbine of claim 15, wherein the diffuser includes a plurality of suction openings.

18. The gas turbine of claim 15, wherein the flow manipulator is located substantially between the actuating opening and the suction opening.

19. The gas turbine of claim 18, wherein the flow manipulator is a pump that is configured to have an intake port proximate the suction opening and a discharge port proximate the actuating opening.

20. The gas turbine of claim 15, further comprising a strut relatively disposed between the inner barrel and an outer wall, wherein the actuating opening is located upstream from the strut.
